(19) United States
(12) Patent Application Publication
(10) Pub. No.: US 2024/0181516 A1
(43) Pub. Date: Jun. 6, 2024

(54) ATTRACTIVE ELECTROMAGNETIC FLANGING METHOD USING STEPPED MAGNETIC FIELD SHAPER FOR SMALL METAL PIPE FITTING, AND DEVICE

(71) Applicant: CHINA THREE GORGES UNIVERSITY, Yichang (CN)

(72) Inventors: Qi XIONG, Yichang (CN); Nuo YAN, Yichang (CN); Shengfei LI, Yichang (CN); Xiang ZHAO, Yichang (CN); Yanxin LI, Yichang (CN); Xiangyi LIU, Yichang (CN); Shuang QIU, Yichang (CN); Fandi SHU, Yichang (CN); Yuan CHEN, Yichang (CN)

(73) Assignee: CHINA THREE GORGES UNIVERSITY, Yichang (CN)

(21) Appl. No.: 18/528,749

(22) Filed: Dec. 4, 2023

(30) Foreign Application Priority Data
Dec. 3, 2022 (CN) 202211544728.1

(51) Int. Cl. B21D 19/08; B21D 26/14; B21D 53/00

(52) U.S. Cl. CPC B21D 19/08; B21D 26/14; B21D 53/00

(57) ABSTRACT

Disclosed are an attractive electromagnetic flanging method using a stepped magnetic field shaper for a small metal pipe fitting, and a device. The problems that an existing electromagnetic flanging method uses a dual-coil and dual-power system, is complicated in control and coordination, and cumbersome in assembly configuration, and a forming effect of using a single coil system is poor are solved. The superior performance of a magnetic field in a specific area can be strengthened during flanging forming through the special stepped magnetic field shaper, such that an effect of replacing provision of an axial background magnetic field coil is achieved. The method solves the problem of insufficient radial electromagnetic force in the single coil system, and simplifies the problems of complicated control and coordination and cumbersome assembly configuration of the dual-coil system. Compared with the drive coil, the stepped magnetic field shaper is easy to manufacture and low in cost, thereby shortening the manufacturing period and facilitating actual batch production.

### CROSS-REFERENCE TO RELATED APPLICATIONS

This application claims priority of the Chinese Patent Application No. 202211544728.1, filed on Dec. 3, 2022, the entire contents of which are hereby incorporated by reference.

### TECHNICAL FIELD

The present disclosure belongs to the field of metal forming and manufacturing, and in particular, to an attractive electromagnetic flanging method using a stepped magnetic field shaper for a small metal pipe fitting, and a device, which are mainly used for the flanging technique of the small metal pipe fitting.

### BACKGROUND

The flanging technique of metal pipe fittings, a common processing technique in industry, can be mainly divided into a contact type and a non-contact type according to processing manners. An existing contact flanging technique mostly adopts mechanical force and hydraulic pressure through many procedures, and are liable to cause defects of post-forming wrinkle and rebound. An existing non-contact flanging technique, i.e., the electromagnetic flanging technique, mainly generates pulse electromagnetic force through drive coils, and drive pipe fittings under flanging. However, the electromagnetic flanging technique still has many shortcomings despite of negligible improvements.

Electromagnetic forming, a high-energy and high-speed pulse forming technology, has fast forming speed and high forming quality, and is non-contact, clean and pollution-free compared with traditional quasi-static machining. It can significantly improve formability of light metal alloys such as aluminum and magnesium alloys at a room temperature and further save plenty of production costs.

The existing electromagnetic flanging technique is complicated in structure and not completely applicable to small metal pipe fittings. For example, Chinese patent CN112387845A discloses an electromagnetic flanging device and method for a large-size pipe fitting based on a magnetic field shaper, which realizes flanging forming of the large-size pipe fitting. However, a forming coil is difficult to wind, and the forming coil and the magnetic field shaper may merely be placed inside a formed pipe fitting for generating required repulsive force, making this method inapplicable to flanging forming of small metal pipe fittings. Chinese patent CN107774780A discloses a method and device for non-contact flaring or flanging of a pipe fitting, which realize electromagnetic flanging of small pipe fittings without arranging the device inside the pipe fittings. According to the device, two drive coils based on independent energization are placed at ends of the pipe fitting, and action time of electromagnetic force is controlled by adjusting discharge time of a power source. However, compared with a single coil flanging system, the system is complicated in control and coordination, and cumbersome in assembly configuration.

### SUMMARY

In order to solve the problem that during the flanging process of a small metal pipe fitting in the prior art, a drive coil may be required to be placed in the pipe fitting in case of adopting a repulsive electromagnetic force flanging method, which is inapplicable to the small metal pipe fitting, and the problem that flanging may be realized by placing two drive coils on outer sides of ends of the pipe fitting to generate attractive electromagnetic force using a dual-coil and dual-power system, which is complicated in system control and coordination and cumbersome in assembly configuration, the present disclosure provides an attractive electromagnetic flanging method using a stepped magnetic field shaper for a small metal pipe fitting, and a device. A special stepped magnetic field shaper may be introduced to a single-coil and dual-power system, and superior performance of a magnetic field in a specific area can be strengthened during flanging forming using the stepped magnetic field shaper, such that an effect of replacing provision of an axial background magnetic field coil can be achieved, and sufficient radial electromagnetic force can be generated for flanging the end of the metal pipe fitting.

The present disclosure uses the following technical solution.

The attractive electromagnetic flanging method using the stepped magnetic field shaper for the small metal pipe fitting includes the following operations.
1, a drive coil may be wound by using a winder, interlayers may be covered with an interlayer insulation material, winding of the drive coil may be completed and then copper bar electrodes may be welded, and a periphery may be reinforced with high-strength fibers and electrically connected to two corresponding pulse capacitor power source systems.
2, annealing pretreatment may be performed on the small metal pipe fitting;
3, an end of the small metal pipe fitting may be sleeved with the drive coil, the stepped magnetic field shaper may be placed in the drive coil and coaxial with a center of the drive coil.
4, the drive coil and the small metal pipe fitting may be fixed by using a hydraulic apparatus.
5, a pulse capacitor may be charged through a charging system to store electric energy in a pulse capacitor bank, a long pulse width current may be generated in the drive coil by closing an electric circuit, and an axial background magnetic field may be generated in a forming area accordingly.
6, if the axial background magnetic field generated by the long pulse width current reaches a peak value, a reverse short pulse width current may be simultaneously loaded in the drive coil to generate an induced eddy current in the small metal pipe fitting.
7, under a combined action of the background magnetic field and the induced eddy current, a radial electromagnetic force may be exerted on the end of the small metal pipe fitting.
8, the small metal pipe fitting may be driven to be flanged by strengthening a magnetic field in an area of the small metal pipe fitting under flanging and changing a distribution of the electromagnetic force through adjustment of the stepped magnetic field shaper.

The drive coil may be arranged outside the small metal pipe fitting and disposed at the end of the small metal pipe fitting. The stepped magnetic field shaper may be arranged inside the drive coil along a radial direction and coaxial with the center of the drive coil.

The drive coil may be simultaneously connected to the two pulse capacitors, and may be configured to generate the long pulse width current and load the reverse short pulse width current in the drive coil.

The long pulse width current and the reverse short pulse width current may be applied to the drive coil. A timing sequence relationship between the long pulse width current and the reverse short pulse width current is that if the long pulse width current reaches the peak value, the reverse short pulse width current may be loaded.

Flanging forming time of the small metal pipe fitting may be a rising edge of the reverse short pulse width current.

The stepped magnetic field shaper may be configured to adjust configuration of the magnetic field, strengthen the magnetic field in the area of the small metal pipe fitting under flanging and a density of the eddy current inside the pipe fitting, and change the distribution of the electromagnetic force.

A device for implementing an attractive electromagnetic flanging method using a stepped magnetic field shaper for a small metal pipe fitting may include:
A drive coil configured to provide an electromagnetic force for a small metal pipe fitting under flanging;
the stepped magnetic field shaper configured to adjust a position and configuration of a magnetic field; and
a pulse capacitor power source system configured to energize the drive coil.

The device may have an axisymmetric structure. The drive coil and the stepped magnetic field shaper may be disposed at an end of the small metal pipe fitting under flanging. The stepped magnetic field shaper may be disposed inside the drive coil, and the stepped magnetic field shaper may be coaxial with the drive coil.

The stepped magnetic field shaper may be an auxiliary accessory for strengthening a magnetic field in a flanging area during electromagnetic flanging. A coil-induced eddy current may be transmitted through cooperation of a stepped structure with a skin effect. A two-dimensional axisymmetric structure of the stepped magnetic field shaper is stepped, and a lower bottom surface of the stepped magnetic field shaper is smaller than an upper bottom surface of the stepped magnetic field shaper. A longitudinal broken seam may be formed between the pipe fitting and the drive coil. The present disclosure has the following beneficial effects.
1. The stepped magnetic field shaper device is introduced to an existing electromagnetic flanging system. The stepped magnetic field shaper device is configured to transfer energy of the drive coil to the area of the small metal pipe fitting under flanging to strengthen the magnetic field in the area under flanging, and make the electromagnetic force distributed more concentrated, such that the small metal pipe fitting is electromagnetically flanged by using a single coil, and the flanging effect is excellent.
2. The small metal pipe fitting is driven by the attractive electromagnetic force, and the drive coil and the magnetic field shaper are not required to be placed in the pipe fitting, such that flanging forming of the metal pipe fitting is no longer limited to a size of an internal space of the metal pipe fitting, and an application scenario of the electromagnetic forming technology is greatly expanded.
3. The economy of the electromagnetic flanging system for the small metal pipe fitting is improved. A winding process of the drive coil during the electromagnetic flanging in the prior art is very complicated, and materials such as epoxy resin and reinforcement fibers needed during winding are very expensive. Compared with the drive coil, the manufacturing cost of the stepped magnetic field shaper is relatively low. In addition, after the stepped magnetic field shaper is introduced, the stepped magnetic field shaper bears the electromagnetic force of the small metal pipe fitting and the drive coil, such that the electromagnetic force on the forming coil is effectively reduced, and the service life of the coil is prolonged.

### BRIEF DESCRIPTION OF THE DRAWINGS

The present disclosure will be further illustrated by way of exemplary embodiments with reference to accompanying drawings.

FIG. 1 is a schematic diagram illustrating an attractive electromagnetic flanging assembly using a stepped magnetic field shaper for a small metal pipe fitting;

FIG. 2 is a schematic diagram illustrating a topological structure of a circuit of a pulse power source system;

FIG. 3 is a schematic diagram illustrating timing sequence coordination of pulse current loading in a coil;

FIG. 4 is a schematic diagram illustrating a three-dimensional structure of a stepped magnetic field shaper;

FIG. 5 is a schematic diagram illustrating current distribution of a flanging system using a stepped magnetic field shaper;

FIG. 6 is a schematic diagram illustrating comparison of a magnetic flux density using a stepped magnetic field shaper with a magnetic flux density without stepped magnetic field shaper;

FIG. 7 is a schematic diagram illustrating comparison of an eddy current density using a stepped magnetic field shaper with an eddy current density without stepped magnetic field shaper;

FIG. 8 is a schematic diagram illustrating a flanging result without a magnetic field shaper;

FIG. 9 is a schematic diagram illustrating a flanging result using a flat magnetic field shaper;

FIG. 10 is a schematic diagram illustrating a flanging result using a trapezoidal magnetic field shaper; and

FIG. 11 is a schematic diagram illustrating a flanging result using a stepped magnetic field shaper.

Reference numerals: 1 drive coil, 2 stepped magnetic field shaper, 3 small metal pipe fitting, 4 radial electromagnetic force, 5 long pulse width current, 6 short pulse width current, 7 trapezoidal magnetic field shaper, and 8 flat magnetic field shaper.

### DETAILED DESCRIPTION

In order to more clearly illustrate the objectives, technical solutions and advantages of the embodiments of the present disclosure, the present disclosure will be further described in detail by way of exemplary embodiments with reference to accompanying drawings. It should be understood that specific embodiments described herein are merely used to explain the present disclosure, rather than limit the present embodiments. In addition, technical features involved in various embodiments of the present embodiments described below can be arbitrarily combined without conflicting with each other.

The present disclosure provides a device for an attractive electromagnetic flanging method using a stepped magnetic field shaper for a small metal pipe fitting. The device may include: a drive coil 1 configured to simultaneously provide a background magnetic field and an induced eddy current for a small metal pipe fitting under flanging; a stepped magnetic field shaper 2 configured to adjust configuration of a magnetic field in an area under flanging by using a special structure; and a pulse capacitor power source configured to energize the drive coil.

The device may have an axisymmetric structure. The drive coil 1 and the stepped magnetic field shaper 2 may be disposed at an end of the small metal pipe fitting under flanging. The stepped magnetic field shaper 2 may be disposed inside the drive coil 1, and the stepped magnetic field shaper 2 may be coaxial with the drive coil 1.

The stepped magnetic field shaper 2 may be an auxiliary accessory for strengthening the magnetic field in the flanging area during electromagnetic flanging. A coil-induced eddy current may be transmitted through cooperation of a stepped structure with a skin effect. A two-dimensional axisymmetric structure of the stepped magnetic field shaper 2 is stepped-shaped, and a lower bottom surface of the stepped magnetic field shaper is smaller than an upper bottom surface of the stepped magnetic field shaper. A longitudinal broken seam may be formed between the pipe fitting and the drive coil 1.

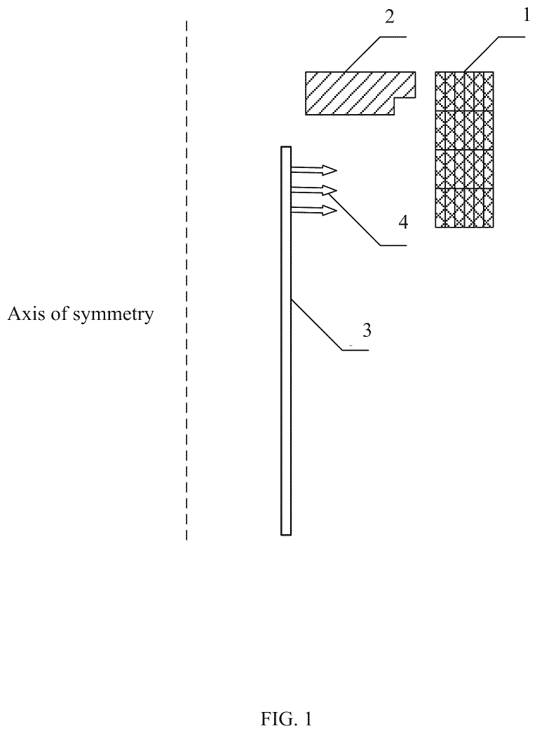

The pulse capacitor power source system may generally consist of a charging system, an energy storage system and a discharging circuit. Firstly, the charging system may charge a capacitor bank, the energy storage system may accumulate energy, a discharging switch may be closed, and the energy storage system may transfer the energy to the drive coil through the discharging circuit, as illustrated in FIG. 1.

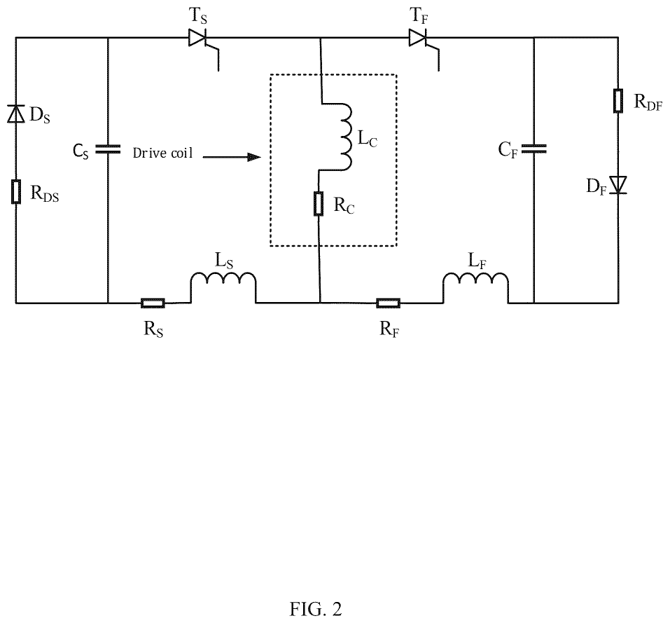

FIG. 2 is a schematic diagram illustrating a topological structure of a circuit of a pulse power source system. As illustrated in FIG. 2, an equivalent inductor and an equivalent resistor of the drive coil 1 may be connected to two ends of the drive coil 1.

An attractive electromagnetic flanging method using a stepped magnetic field shaper for a small metal pipe fitting may include the following operations.
1, a drive coil 1 may be wound by using a winder, interlayers may be covered with an interlayer insulation material, winding of the drive coil may be completed and then copper bar electrodes may be welded, and a periphery may be reinforced with high-strength fibers and electrically connected to two corresponding pulse capacitor power source systems.
2, annealing pretreatment may be performed on the small metal pipe fitting 3.
3, an end of the small metal pipe fitting 3 may be sleeved with the drive coil 1, the stepped magnetic field shaper 2 may be placed in the drive coil 1 and coaxial with a center of the drive coil 1.
4, the drive coil 1 and the small metal pipe fitting 3 may be fixed by using a hydraulic apparatus, a pressure intensity being regularly set to be within a range of 1 Mpa-1.5 Mpa.
5, a pulse capacitor may be charged through a charging system to store electric energy in a pulse capacitor bank, a long pulse width current 5 may be generated in the drive coil 1 by closing an electric circuit, and an axial background magnetic field may be generated in a forming area accordingly.
6, if the axial background magnetic field generated by the long pulse width current 5 reaches a peak value, a reverse short pulse width current 6 may be simultaneously loaded in the drive coil 1 to generate an induced eddy current in the small metal pipe fitting 3.
7, under a combined action of the background magnetic field and the induced eddy current, a radial electromagnetic force may be exerted on the end of the small metal pipe fitting 3.
8, the small metal pipe fitting 3 may be driven to be flanged by strengthening a magnetic field in an area of the small metal pipe fitting 3 under flanging and changing a distribution of the electromagnetic force through adjustment of the stepped magnetic field shaper 2.

Specifically, the long pulse width current 5 and the reverse short pulse width current 6 may be applied to the drive coil 1. A timing sequence relationship between the long pulse width current 5 and the reverse short pulse width current 6 may be that if the long pulse width current 5 reaches a peak value, the reverse short pulse width current 6 is loaded.

Specifically, effective loading time of the radial electromagnetic force may be a rising edge of loading of the short pulse width current.

Specifically, the drive coil may be connected to a long pulse width current generation circuit through a switching tube T_{S}. The drive coil may also be connected to a short pulse width current generation circuit through a switching tube T_{F}.

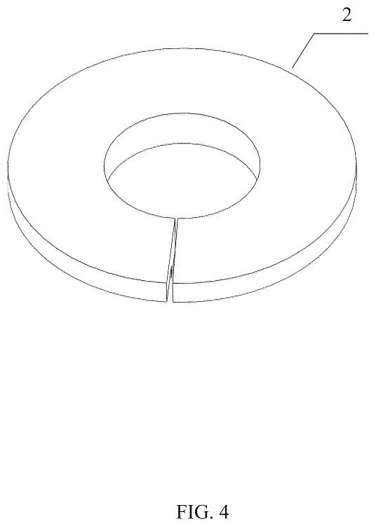

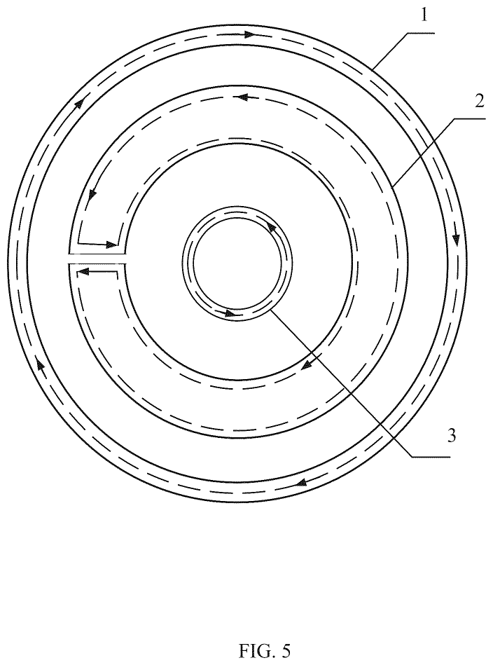

When a pulse current is applied to the drive coil 1, an induced eddy current may be generated in the stepped magnetic field shaper 2. As illustrated in FIGS. 4-5, an air gap in the stepped magnetic field shaper 2 may block circulation of the current in the stepped magnetic field shaper 2. Due to the skin effect, the induced current merely flows on a surface of the stepped magnetic field shaper 2. As a result, a direction of the induced current in the stepped magnetic field shaper 2 is from an upper surface of the stepped magnetic field shaper 2 to a lower surface of the stepped magnetic field shaper 2, thereby forming a closed loop. Due to the skin effect and a situation that an area of the lower surface of the stepped magnetic field shaper 2 is smaller than an area of the upper surface of the stepped magnetic field shaper 2, a current density of the lower surface of the stepped magnetic field shaper 2 is much greater, and a magnetic field generated in a nearby area of the lower surface of the stepped magnetic field shaper 2 is relatively strong. Furthermore, the induced current in the stepped magnetic field shaper 2 may generate an induced eddy current in the small metal pipe fitting, and a magnetic field generated by the eddy current and a magnetic field generated by the current of the drive coil 1 may also strengthen each other, such that the magnetic field may be strengthened in an area between the lower surface of the stepped magnetic field shaper 2 and the small metal pipe fitting 3, a density of the induced eddy current inside the pipe fitting may also be strengthened, thereby effectively enhancing the electromagnetic force, as illustrated in FIGS. 5-7.

A pulse magnetic field may be generated by a pulse current. The pulse magnetic field may generate the induced eddy current in the small metal pipe fitting, and a combined action of the induced eddy current and the pulse magnetic field may generate a Lorentz magnetic force to drive a metal material to be deformed. A multi-physical field analysis and calculation formula of the present disclosure may be presented by:

$$\{ \begin{matrix}{f}_{z} = {J}_{e} \times {B}_{r} \\ {F}_{r} = {J}_{e} \times {B}_{z}\end{matrix} ⇒ {f}_{r} = \{ \begin{matrix}{J}_{L} \times {B}_{L - Z} , ( t < {t}_{1} ) \\ - ( {J}_{S} - {J}_{L} ) \times ( {B}_{L - Z} - {B}_{S - Z} ) , ( t > {t}_{1} )\end{matrix}$$

In the formula, F_{z} and Fᵣ denote an axial Lorentz force and a radial Lorentz force respectively; Jₑ denotes the density of the induced eddy current on the pipe fitting, and a clockwise direction is defined as a positive direction; B_{z} and Bᵣ denote an axial magnetic field component and a radial magnetic field component respectively; J_{L} denotes the induced eddy current generated by the long pulse width current on the small metal pipe fitting, and J_{S} denotes the induced eddy current generated by the short pulse width current on the small metal pipe fitting; B_{L-Z} denotes an axial magnetic field generated by the long pulse width current in the flanging area of the small metal pipe fitting, and B_{S-Z} denotes an axial magnetic field generated by the short pulse width current in the flanging area of the small metal pipe fitting; and t denotes time, t₁ denotes a time point when the long pulse width current reaches the peak value, and t₂ denotes a time point when the short pulse width current reaches the peak value.

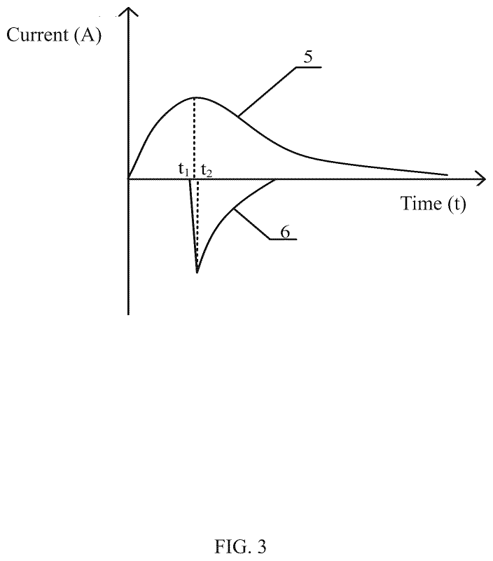

Two pulse capacitor power sources may be connected in parallel at the two ends of the drive coil 1 (see FIG. 2). A pulse width of the short pulse width current 6 may be much smaller than a pulse width of the long pulse width current 5 (see FIG. 3), such that the influence of the short pulse width current 6 on the axial background magnetic field may be ignored. In addition, the rising edge of the long pulse width current 5 may be slow, and the influence on the induced eddy current may be ignored. If the long pulse width current 5 reaches the peak value, the reverse short pulse width current 6 may be loaded to use to the greatest extent the axial magnetic field generated by the long pulse width current 5. In this case, a circumferential eddy current and the axial magnetic field may interact with each other to generate a maximum radial electromagnetic force in the small metal pipe fitting 3, thereby realizing flanging forming of the small metal pipe fitting.

In the model illustrated in FIG. 1, first, the long pulse width current 5 may be applied to the drive coil 1, and the axial background magnetic field may be in a downward direction. When the long pulse width current 5 reaches the peak value, the short pulse width current 6 may be loaded, and the induced eddy current in the small metal pipe fitting 3 may be in a circumferential direction counterclockwise. According to the above formula, the Lorentz force generated by the axial Lorentz force and the radial Lorentz force is a radial force, thereby driving the small metal pipe fitting to be flanged.

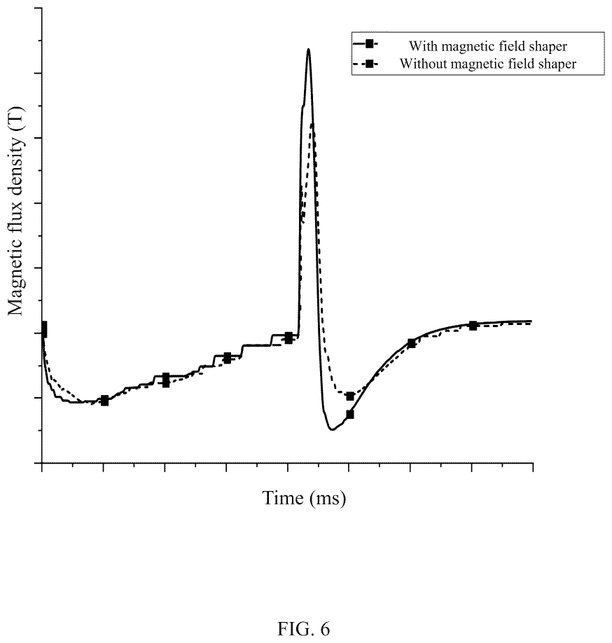

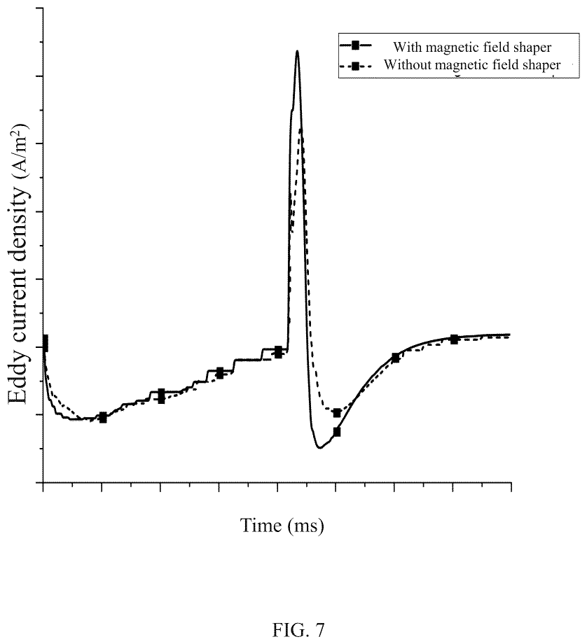

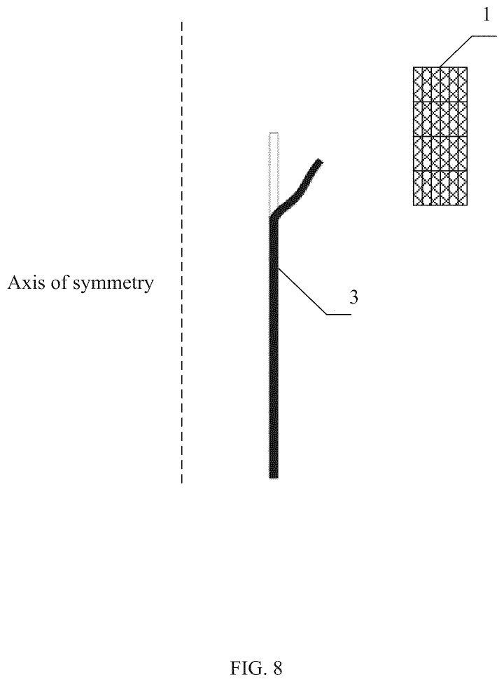

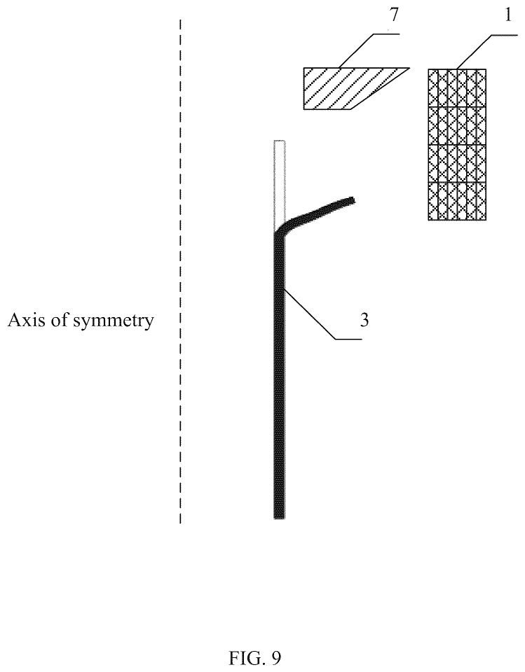

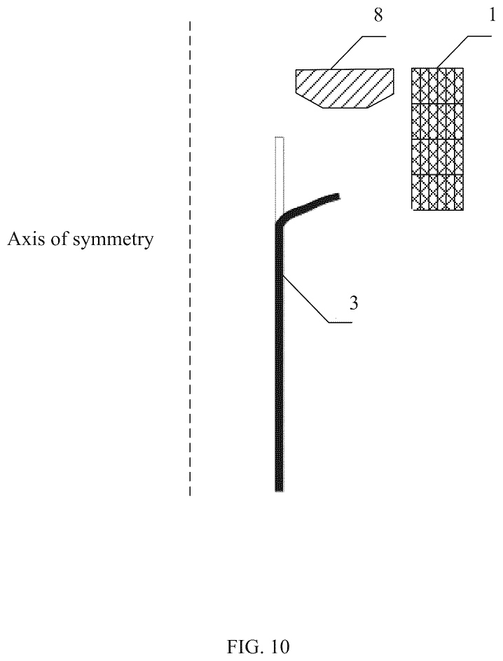

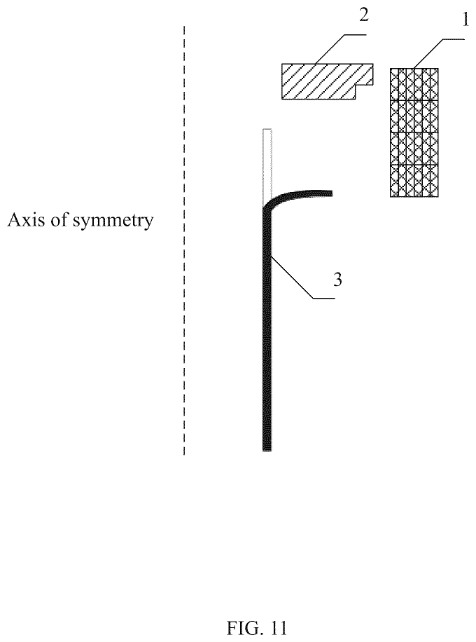

According to the embodiments of the present disclosure, numerical analysis may be performed using multi-physical field software COMSOL, and simulation results are shown in FIGS. 6-7. In a flanging solution not using the magnetic field shaper, a flanging effect of the small metal pipe fitting is shown in FIG. 8. In a flanging solution using the flat magnetic field shaper, a flanging effect of the small metal pipe fitting is shown in FIG. 9. In a flanging solution using the trapezoidal magnetic field shaper, a flanging effect of the small metal pipe fitting is shown in FIG. 10. In a flanging solution using the stepped magnetic field shaper, a flanging effect of the small metal pipe fitting is shown in FIG. 11. It can be found through the numerical simulation analysis that the stepped magnetic field shaper significantly improves the flanging forming effect of the small metal pipe fitting.

What is claimed is:

1. An attractive electromagnetic flanging method using a stepped magnetic field shaper for a small metal pipe fitting, comprising:
1, winding a drive coil (1) by using a winder, covering interlayers with an interlayer insulation material, completing winding of the drive coil (1) and then welding copper bar electrodes, and reinforcing a periphery with high-strength fibers and electrically connecting to two corresponding pulse capacitor power source systems;
2, performing annealing pretreatment on a small metal pipe fitting (3);
3, sleeving an end of the small metal pipe fitting (3) with the drive coil (1), placing a stepped magnetic field shaper (2) in the drive coil (1), and making the stepped magnetic field shaper (2) be coaxial with a center of the drive coil (1);
4, fixing the drive coil (1) and the small metal pipe fitting (3) by using a hydraulic apparatus;
5, charging a pulse capacitor through a charging system to store electric energy in a pulse capacitor bank, generating a long pulse width current (5) in the drive coil (1) by closing an electric circuit, and generating an axial background magnetic field in a forming area accordingly;
6, if the axial background magnetic field generated by the long pulse width current (5) reaches a peak value, simultaneously loading a reverse short pulse width current (6) in the drive coil (1) to generate an induced eddy current in the small metal pipe fitting (3);
7, under a combined action of the background magnetic field and the induced eddy current, applying a radial electromagnetic force to the end of the small metal pipe fitting (3); and
8, driving the small metal pipe fitting (1) to be flanged by strengthening a magnetic field in an area of the small metal pipe fitting (1) under flanging and changing a distribution of the electromagnetic force through adjustment of the stepped magnetic field shaper (2).

2. The method according to claim 1, wherein the drive coil (1) is arranged outside the small metal pipe fitting (3) and disposed at the end of the small metal pipe fitting (3), and the stepped magnetic field shaper (2) is arranged inside the drive coil (1) and radially coaxial with the center of the drive coil (1).

3. The method according to claim 1, wherein the drive coil (1) is simultaneously connected to two pulse capacitors and is configured to generate the long pulse width current (5) and load the reverse short pulse width current (6) in the drive coil (1).

4. The method according to claim 1, wherein the long pulse width current (5) and the reverse short pulse width current (6) are applied to the drive coil (1), and a timing sequence relationship between the long pulse width current (5) and the reverse short pulse width current (6) is that if the long pulse width current (5) reaches the peak value, the reverse short pulse width current (6) is loaded.

5. The method according to claim 1, wherein flanging forming time of the small metal pipe fitting (3) is a rising edge of the reverse short pulse width current 6).

6. The method according to claim 1, wherein the stepped magnetic field shaper (2) is configured to adjust configuration of a magnetic field, strengthen the magnetic field in the area of the small metal pipe fitting (3) under flanging and a density of an eddy current inside the pipe fitting, and change a distribution of the electromagnetic force.

7. A device for implementing an attractive electromagnetic flanging method using a stepped magnetic field shaper for a small metal pipe fitting according to claim 1, comprising:
a drive coil (1) configured to provide an electromagnetic force for a small metal pipe fitting (3) under flanging;
a stepped magnetic field shaper (2) configured to adjust a position and configuration of a magnetic field; and
a pulse capacitor power source system configured to energize the drive coil (1).

8. The device according to claim 7, wherein the device has an axisymmetric structure, the drive coil (1) and the stepped magnetic field shaper (2) are disposed at an end of the small metal pipe fitting under flanging, the stepped magnetic field shaper (2) is arranged inside the drive coil (1), and the stepped magnetic field shaper (2) is coaxial with the drive coil (1).

9. The device according to claim 7, wherein the stepped magnetic field shaper (2) is an auxiliary accessory for strengthening a magnetic field in a flanging area during electromagnetic flanging, and a coil-induced eddy current is transmitted through cooperation of a stepped structure with a skin effect; a two-dimensional axisymmetric structure of the stepped magnetic field shaper (2) is stepped, and a lower bottom surface of the stepped magnetic field shaper (2) is smaller than an upper bottom surface of the stepped magnetic field shaper; and a longitudinal broken seam is formed between the pipe fitting and the drive coil (1).
